(19) United States
(12) Patent Application Publication
(10) Pub. No.: US 2007/0123166 A1
(43) Pub. Date: May 31, 2007

(54) System, method and apparatus for pre-pairing bluetooth enabled devices

(76) Inventors: Arnold Sheynman, Northbrook, IL (US); Michael L. Charlier, Palatine, IL (US); Christopher S. Gremo, Mchenry, IL (US)

Correspondence Address: MOTOROLA INC, 600 NORTH US HIGHWAY 45, ROOM AS437, LIBERTYVILLE, IL, 60048-5343, US

(21) Appl. No.: 11/288,516

(22) Filed: Nov. 29, 2005

(51) Int. Cl. H04B 7/00

(52) U.S. Cl. 455/41.2

(57) ABSTRACT

Disclosed are a method, system and apparatus for injecting a Bluetooth address of a Bluetooth device (202) into a mobile communication device (204) to avoid the discovery process in pairing. The method includes receiving by an intermediary device (21), Bluetooth address data associated with a Bluetooth device (202), converting the Bluetooth address data to a format suitable for storage in a mobile communication device (204), to form converted Bluetooth address data, and transferring by the intermediary device (210), the converted Bluetooth address data to memory in the mobile communication device (204).

### FIELD

This disclosure relates to Bluetooth enabled devices, and more particularly to pairing two or more devices to avoid or reduce steps in the discovery process therebetween.

### BACKGROUND

Bluetooth (BT) wireless technology provides a manner in which many wireless devices may communicate with one another, without connectors, wires or cables. Bluetooth technology uses the free and globally available unlicensed 2.4 GHz radio band, for low-power use, allowing two Bluetooth devices within a range of up to 10 to 100 meters to share data with throughput up to 2.1 Mbps. Each Bluetooth device can simultaneously communicate with many other devices.

Current common uses for Bluetooth technology include those for headsets, cellular car kits and adapters. Moreover, Bluetooth technology is currently used for connecting a printer, keyboard, or mouse to a personal computer without cables. Also, since Bluetooth technology can facilitate delivery of large amounts of data, computers may use Bluetooth for connection to the Internet. Mobile communication devices such as cellular telephones may transfer photos, video or ring tones between them. Additional functionality is expected to continue to expand.

Before two Bluetooth enabled devices may communicate, the devices must be paired. Bluetooth pairing occurs when the two Bluetooth enabled devices become a trusted pair. To become a trusted pair, two Bluetooth devices must first complete a specific discovery and authentication process. When a first Bluetooth device recognizes a second Bluetooth device and complete a specific discovery and authentication process, each device can automatically accept communication between them.

Device discovery is the procedure a Bluetooth wireless device uses to locate nearby Bluetooth wireless devices with which it wishes to communicate. Exchanging the Bluetooth addresses of the discoverable devices, their friendly names and other relevant information via establishing a short term connection with each device in the vicinity can be a time consuming procedure. The procedure can involve having one Bluetooth wireless device transmitting an inquiry request to other Bluetooth wireless devices scanning for inquiry requests. A device that transmits the inquiry request (a potential master) is said to be discovering devices while the device that is scanning for inquiry requests is said to be discoverable. The discoverable device (a potential slave) performs a process called inquiry scanning, during which it looks for an inquiry request. Once a discoverable device receives an inquiry request, it responds with Frequency Hopping Synchronization (FHS) packets. These packets include, among other fields, the discoverable device's 6-byte Bluetooth device address and 3-byte Class of Device (COD).

The list of the discovered devices is presented to the user. The user may select the desired device to be paired with. In one example, the Bluetooth device is a headset, and another Bluetooth device is a mobile communication device such as a cellular telephone.

During the device discovery procedure it is possible to obtain further information from discoverable devices such as the Bluetooth devices friendly names. To do this the discovering device sends a page request to the discovered device's Bluetooth device address(es), at which point the discovering device initiates a short term connection with the discoverable device(s) and becomes a master. When a discoverable device responds to a page request, it becomes a slave. At this point, the devices aren't paired, but the master can send a request for the slave's friendly name. For example, the friendly name may look like “Bluetooth Headset”.

Typically instead of the hexadecimal Bluetooth addresses the list of devices' friendly names is presented to the user at the end of the discovery procedure. At this moment the user can select the Bluetooth wireless device he/she desires to start the communication with. After the user makes a selection, the discovering device can initiate a connection with the newly discovered device using the discovered device's Bluetooth device address. Without device discovery a Bluetooth wireless device would not know the Bluetooth device address of other Bluetooth devices which is required information for establishing a connection between the devices.

The master device is a device that initiates a connection. The device that accepts a connection becomes the slave device. For example, when the telephone initiates the discovery and pairing procedure it behaves as a master and the headset becomes a slave. Next time when the user powers the headset up the headset actively looks for the previously paired telephone, initiates connection to it and becomes a master. Upon accepting connection, the telephone becomes a slave. Furthermore, during the ongoing connection the master/slave roles can be switched if required.

During the discovery process, the devices must be in discovery mode. There may be a toggle, switch or other setting mechanism for making the devices either discovering or discoverable ones.

When the telephone and the headset are delivered to the user as a bundled solution, the devices are not pre-paired. The initial “out-of-the-box” pairing Bluetooth enabled telephones and headsets is required to operate the set, however, the complicated process causes certain difficulties and confusion among the users.

In practice, when a user receives a device such as a headset and a device such as a cellular telephone, the user is required to prepare both devices for discovery and the subsequent authentication process. Unfortunately, there are a substantial number of prompts generated by both devices so that the process of pairing can be difficult for most consumers. Moreover, the communication between the devices being in discoverable mode could be easily accessed by the hackers. Thus, it may be beneficial if the number of steps during the discovery process were reduced or eliminated.

### SUMMARY

A system, method, and apparatus for reducing or eliminating steps for a discovery process. Bluetooth address data associated with a Bluetooth device can be transferred via an intermediary device. The Bluetooth address data can be converted to a format suitable to reduce or eliminate steps in the discovery process.

### BRIEF DESCRIPTION OF THE DRAWINGS

FIG. 1 is a diagram of an embodiment of a system including a device to extract the Bluetooth address from packaging indicia of a slave device and a device to inject it into a mobile communication device;

FIG. 2 shows a signal flow diagram of a slave device, the intermediary device and a master device; and

FIG. 3 is a flow chart illustrating an embodiment of the pre-pairing process described herein.

### DETAILED DESCRIPTION

Described herein are methods, a system and an apparatus for injecting the Bluetooth address into a device that will initiate a pairing procedure at the very first time by an intermediary device to eliminate the discovery process in pairing two Bluetooth enabled devices.

Two Bluetooth enabled devices may be manufactured by different manufacturers and/or in two different locations. At a next stage, sellers or distributors may package two devices together in one package so that they may be sold together. The devices are not paired when they arrive at this stage of their distribution chain. The device, such as a headset, mouse, car kit or any other device can include some sort of indicia, such as a bar code, on its packaging or housing containing its Bluetooth address and in another embodiment the Bluetooth address plus its friendly name. Further, there may be a database associated with a group or lot of devices that maintains their Bluetooth addresses respectively. In any event, the Bluetooth address is readable by the intermediary device without engaging the two devices, master and slave, in the discovery process. Accordingly, the opportunities to accidentally pair an incorrect pair, or to accidentally leave one or the other device in discovery mode and therefore open to hackers, may both be avoided.

Disclosed herein is a method that includes receiving by an intermediary device, Bluetooth address data and as mentioned above, in addition, a friendly name associated with a Bluetooth device without engaging in discovery. In the interest of saving time during the final pair process steps carried out by the user, the addition of the friendly name during the described process is a time saving process. The intermediary device can be a preprogramming station. The Bluetooth address data may be in any format. The intermediary device can convert the Bluetooth address data to a format suitable for storage in reserved memory of a mobile communication device, to form converted Bluetooth address data. The reserved memory may exist in the form of the pre-defined element of the telephone's Electrically-Erasable Programmable Read-Only Memory (EEPROM). The reserved memory resides on the telephone and is intended and reserved to store the information about the remote Bluetooth devices that are already paired or will be paired. The intermediary device can then transfer the converted Bluetooth address data to reserved memory in the mobile communication device. A preprogramming station can therefore extract the Bluetooth address from the device packaging indicia such as a bar code, a database, or other place and write it to the dedicated part of the communication device EEPROM. In this manner, discovery during pairing can be reduced or eliminated.

Before describing in detail embodiments that are in accordance with the present disclosure, it should be observed that the embodiments reside primarily in combinations of method steps and apparatus components related to preparing a mobile communications device for pairing with a Bluetooth device. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the disclosure described herein may be comprised of one or more conventional processors and unique stored program instructions that control the one or more processors to implement, in conjunction with certain non-processor circuits, some, most, or all of the functions of preparing a mobile communications device for pairing with a Bluetooth device described herein. The non-processor circuits may include, but are not limited to, a radio receiver, a radio transmitter, signal drivers, clock circuits, power source circuits, and user input devices. As such, these functions may be interpreted as steps of a method to perform preparing a mobile communications device for pairing with a Bluetooth device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

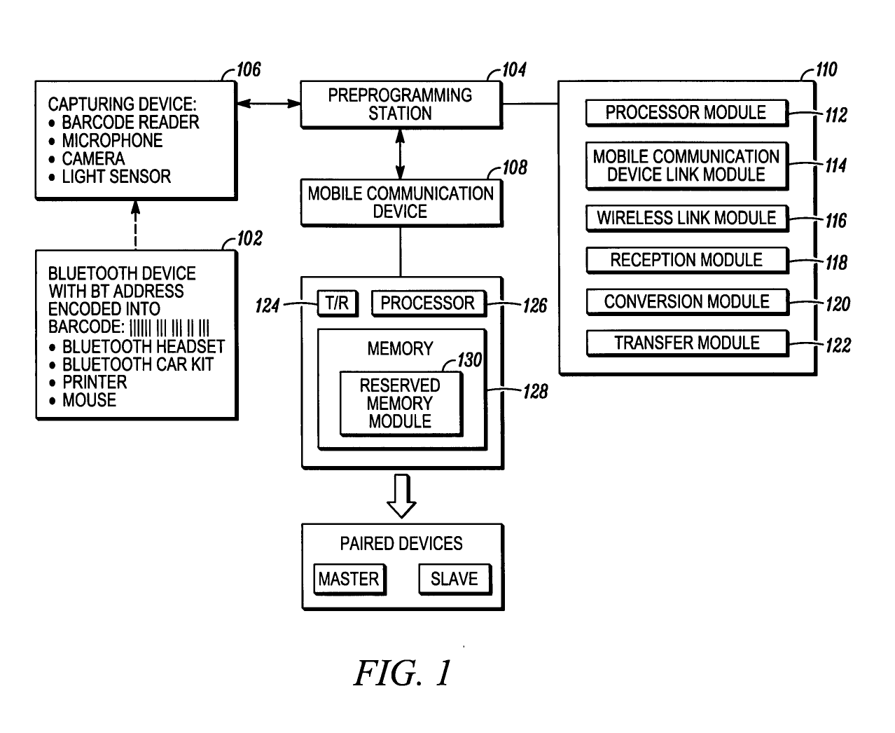

FIG. 1 is a diagram of an embodiment of a system including a device to extract the Bluetooth address from packaging indicia of a device and a device to inject it into a mobile communication device. Further depicted is a representation of a Bluetooth enabled headset or other Bluetooth device 102. The headset packing or housing can have a bar code affixed to it. The intermediary device or preprogramming station 104 can be equipped with a capturing device 106 that is herein depicted as a bar code reader to extract the Bluetooth address from the packaging indicia.

The capturing device 106 may be any type of input device to the preprogramming station dependent on the type of data used to store or display a Bluetooth address of the device. The capturing device may be, for example, a charge-coupled device camera, a charge modulation device camera, an RFID scanner, a dual tone multi-frequency detector, an optical or infrared light detector, and/or any other type of input device that can be configured to receive the Bluetooth address data embedded in any form of data storage or indicia.

Once captured, the Bluetooth address data can be received from the capturing device 106 and processed by the intermediary device 104, so there is a conversion from its original format to a format that is suitable for storage in a mobile communication device 108. Once converted, the Bluetooth address data can be injected into the reserved memory of the mobile communication device 108. The intermediary device 104 may wirelessly receive the Bluetooth address data from the capturing device 106 and may wirelessly transmit, transfer and/or inject the converted address data to the mobile communication device 108. The transfer operations of the intermediary device may also be via wires or any other means for transferring data between devices.

The preprogramming station 104 accordingly may include modules 110 that can contain instruction modules that are hardware or software to carry out the various tasks associated with receiving the address, converting the address and transferring the address to the communication device. The receiving task may include reading the Bluetooth address of the device from the source, whether the Bluetooth address is in the form of indicia, or is in an electronic form, or in both forms. The receiving task may also include capturing, deciphering and decoding the Bluetooth address. While these electronic components of the preprogramming station 104 are shown as part of the preprogramming station 104, any of their functions in accordance with this disclosure may be wirelessly or via wires, transmitted to and received from electronic components remote to the preprogramming station 104. The preprogramming station modules 110 include a processor module 112, a mobile communication device link module 114, a wireless link module 116, a reception module 118, a conversion module 120 and a transfer module 122. The sequence of the operation of the modules will be discussed in more detail below.

The process of injection into the memory of a communication device can vary depending upon the type of mobile communication device. A wide variety of communication devices that have been developed for use within various networks are included in this discussion. Handheld communication devices include, for example, cellular telephones, messaging devices, mobile telephones, personal digital assistants (PDAs), notebook or laptop computers incorporating communication modems, mobile data terminals, application specific gaming devices, video gaming devices incorporating wireless modems, audio and music players and the like. Bluetooth enabled industrial devices may also be paired as described herein. Other devices such as personal computers, television sets and stereo equipment may also be paired with Bluetooth devices in the manner described herein. It is understood that any device that is Bluetooth enabled is a mobile communication device. The mobile communication device depicted in FIG. 1 can also include a transceiver 124, a processor 126 and a memory 128 including the above-mentioned reserved memory module 130.

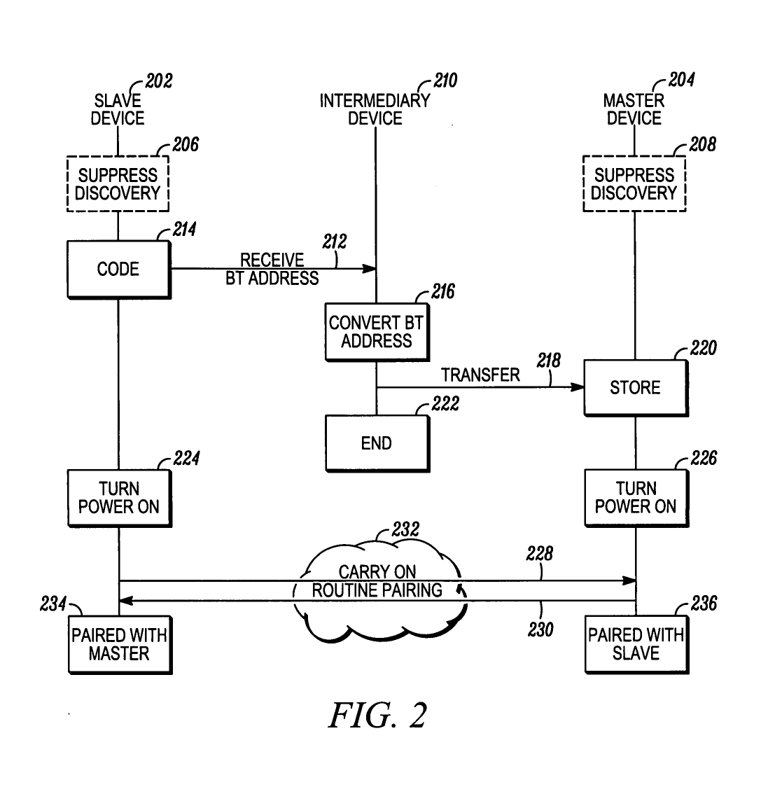

FIG. 2 shows a signal flow diagram of a slave device 202, the intermediary device 210 and a master device 204. The slave device 202 and the master device 204 may optionally have their discovery processes suppressed in steps 206 and 208. In this way, a user may not accidentally turn on discovery during the final pairing steps. Accordingly, the opportunities to accidentally pair an incorrect pair, or to accidentally leave one or the other devices in discovery mode and therefore open to hackers, may both be avoided.

The intermediary device 210 may receive 212 the Bluetooth address data 214 in any of the manners described above. The intermediary device then converts the Bluetooth address data 216 into a form suitable for storage in the master device 204. The intermediary device 210 can transfer or inject 218 the converted Bluetooth address data into the master device 204 so that it may store the data in its memory 220. The intermediary device may therefore end its task 222.

A user or other entity may wish to finalize the pairing process. In that event the power of the slave device can be activated 224 and the power of the master device can be activated 226. Alternately, the power can already be on from the preceding steps. Signals 228 and 230 are transmitted between the devices to carry on the routine pairing procedures 232. The discovery process may be suppressed for the final pairing procedures which can include, installing the link key in the slave device 202, installing the encryption key in the slave device 202, installing the link key in the master device 204, and installing the encryption key in the master device 204. The pairing can therefore be accomplished between the Bluetooth (slave) device 234 and the mobile communication (master) device 236. It is understood that the steps for pairing may change as the Bluetooth specification changes and that does not affect the scope of this discussion.

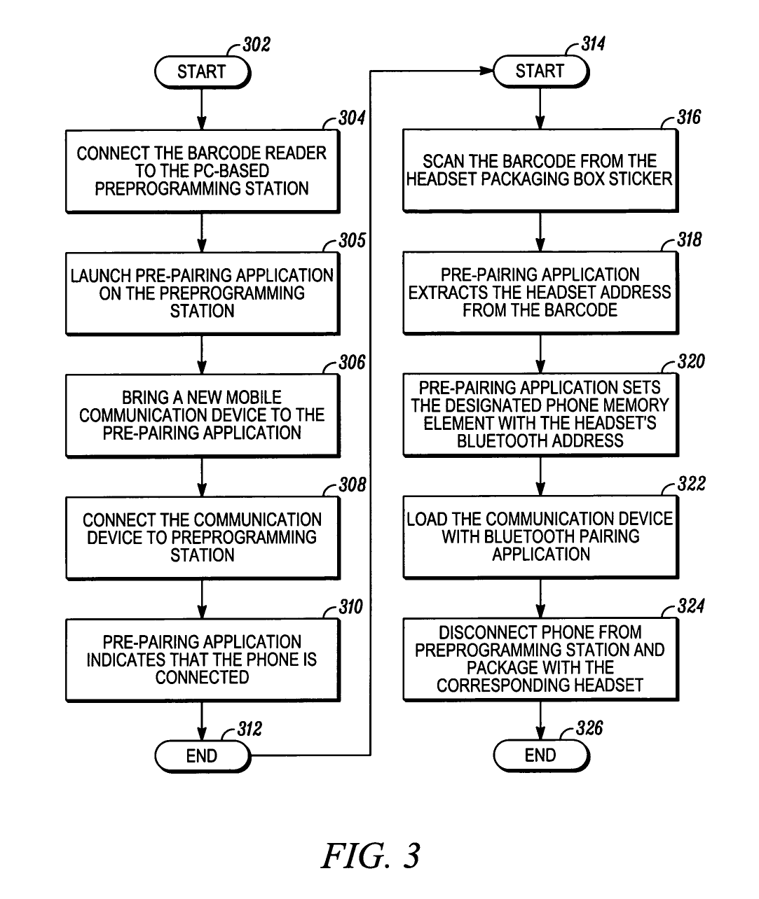

FIG. 3 is a flow chart illustrating an embodiment of the pre-pairing process described herein. As mentioned above, the pre-pairing process, that is the elimination or reduction of the discovery process in pairing, may take during a distribution process. A product such as a headset may be packaged together with a mobile communication device. It is understood that more than two devices may be pre-paired in this process as well. The particular types and number of pre-paired devices depends upon the distribution system and goals. While pairing indicates that two devices are paired, it is understood that the pairing, the coordination, or assembly of more than two Bluetooth enable devices is within the scope of this discussion.

At the start of the process 302, a barcode reader or other Bluetooth address capturing device is connected to a preprogramming station 304 that can be, for example, PC-based. The pre-pairing application is launched 305 and a new mobile communication device is introduced to the pre-pairing application 306. Depending upon the method of injection, the communication device is connected or positioned at the preprogramming station 308, and then there is an indication that the communication device is in position 310 and the first part of this described process is ended 312.

After an initial connection is created between two Bluetooth wireless devices, it is sometimes desirable to verify or authenticate the newly connected device. Bonding is the procedure of a Bluetooth wireless device authenticating another Bluetooth wireless device, and is dependent on a shared authentication key. If the devices do not share an authentication key, a new key can be created before the bonding process can complete. Generation of the authentication key is called pairing. The pairing process can involve generation of an initialization key and an authentication key, followed by mutual authentication. The initialization key can be based on user input, a random number and the Bluetooth device address of one of the devices. The user input may be referred to as a Personal Identification Number (PIN) or passkey and may be up to 128-bits long. The passkey is the shared secret between the two devices. The authentication key can be based on random numbers and Bluetooth device addresses from both devices. The initialization key is used for encryption when exchanging data to create the authentication key, and is thereafter discarded. When the pairing process is completed, the devices have authenticated each other. Both devices can share the same authentication key, often called a combination key since both devices have contributed to the creation of the key. When two devices have completed the pairing process they may store the authentication key for future use. The devices may then be paired and may authenticate each other through the bonding process without the use of a passkey. Devices may stay paired until one device requests a new pairing process, or the authentication key can be deleted on either of the devices. Storing the authentication key is useful for devices frequently connecting to each other, such as a cellular telephone frequently connecting to the Bluetooth wireless headset. The bonding procedure can then complete without user input and the user is relieved of figuring out a new passkey for every connection.

FIG. 3 is a flow chart illustrating an embodiment of the pre-pairing process described herein. The steps 302-312 of FIG. 3 are performed at, for example, the handset manufacturer distribution center (DC) but can of course be performed at a different place. A device such as a mobile communication device, for example, a cellular telephone, to be shipped bundled with a Bluetooth headset can be physically brought to the preprogramming station and connected to it. The connection can be wired to the preprogramming station or the process may be wireless. These steps may or may not be synchronized with the steps 302-312. Then the labeled headset can be delivered to the DC and brought in the contact with capturing device of FIG. 1. At this time, the actual injection starts preferably if the conditions from steps 302-312 can be satisfied, i.e. the device may be coupled to the preprogramming station, the pre-pairing application has started, etc., e.g. the device can be ready for injection and the Bluetooth device can be reachable by the capturing device.

Another part of this described embodiment of the process can begin at 314. It is understood that the method of receiving by an intermediary device, Bluetooth address data associated with a Bluetooth device, converting the Bluetooth address data to a format suitable for storage in a mobile communication device, to form a converted Bluetooth address data, and transferring by the intermediary device, the converted Bluetooth address data to reserved memory in the mobile communication device, can be carried out in any suitable sequence of steps. Accordingly, the procedure described by steps 314-326 may be ready to be executed. The Bluetooth pairing application mentioned in step 322 preferably completes the pairing process and can be executed by the user or other entity.

In the example where the Bluetooth address is embedded in a barcode, the pre-pairing application can scan the barcode from the headset packaging box sticker 316. The pre-pairing application may extract the headset address from the barcode 318. The pre-pairing application may set the designated telephone memory element with the headset's Bluetooth address 320. The communication device may be then loaded with the Bluetooth pairing application 322. Once the Bluetooth address of the headset is in the memory of the mobile communication device, the telephone can be disconnected from the pre-programming station and packaged with the corresponding headset 324. The second phase of the pre-pairing process ends at 326.

The application that can be launched by the user on the device can extract from the reserved EEPROM memory previously injected information (i.e. the Bluetooth device's address and corresponding friendly name) and can complete the pairing with the bundled Bluetooth headset. In this manner the discovery procedure can be omitted. It is understood that the Bluetooth device's Bluetooth address (and potentially friendly name) reading from the Bluetooth device's packaging (or otherwise) barcode label and following injection into the handset may not be done during the actual pairing but in the anticipation of pairing. Furthermore the process described herein may not be done not by the end user but by the intermediary entity. Accordingly, the Bluetooth device's Bluetooth address (and potentially friendly name) reading from the Bluetooth device's barcode label and following injection into the handset may not be synchronized with the actual pairing procedure executed by the end user or other entity.

As mentioned above, the pre-pairing process, that is the elimination of the discovery process in pairing for the end user, may take place during a distribution process. A product such as a headset may be packaged together with a mobile communication device. It is understood that more than two devices may be pre-paired in this process as well. The particular types and number of pre-paired devices depends upon the distribution system and goals. While pairing indicates that two devices are paired, it is understood that the pairing, the coordination, or assembly of more than two Bluetooth enable devices is within the scope of this discussion.

While the above-described processing method relates to a barcode application, it is understood that the Bluetooth address data can be embedded in any form of data storage and can be retrieved in any manner suitable. The process by which the data is converted and injected into a master device such as a mobile communication device can take any suitable form as well. In this manner, the discovery process can be eliminated to avoid certain problems with the discovery process.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the disclosure as determined by the appended claims, as may be amended during the pendency of this application for patent, and all equivalents thereof, when interpreted in accordance with the breadth to which they are fairly, legally and equitable entitled.

In the foregoing specification, specific embodiments of the present disclosure have been described. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

1. A method for injecting a Bluetooth address of a Bluetooth device into a mobile communication device, comprising:
receiving by an intermediary device, Bluetooth address data associated with a Bluetooth device;
converting the Bluetooth address data to a format suitable for storage in a mobile communication device, to form a converted Bluetooth address data; and
transferring by the intermediary device, the converted Bluetooth address data to reserved memory in the mobile communication device.

2. The method of claim 1, further comprising:
transferring a friendly name by the intermediary device to the reserved memory of in the mobile communication device.

3. The method of claim 1, wherein receiving by an intermediary device, Bluetooth address data associated with a Bluetooth device comprises:
reading, with a bar code reader, Bluetooth address data encoded in a bar code; and
decoding the Bluetooth address data encoded in the bar code.

4. The method of claim 1, wherein receiving by an intermediary device, Bluetooth address data associated with a Bluetooth device comprises:
capturing, with at least one selected from the group of a charged-coupled device camera and a charge modulation device camera, an image of Bluetooth address data encoded in a bar code;
deciphering the image to form Bluetooth address data encoded in a bar code; and
decoding the Bluetooth address data encoded in the bar code.

5. The method of claim 1, wherein receiving by an intermediary device, Bluetooth address data associated with a Bluetooth device comprises:
receiving dual tone multi-frequency tones in a predetermined format emitted by the Bluetooth device, the tones encoding Bluetooth address data; and
decoding the Bluetooth address data encoded in the dual tone multi-frequency tones.

6. The method of claim 1, wherein receiving by an intermediary device, Bluetooth address data associated with a Bluetooth device comprises:
receiving light flashes in a predetermined format emitted by the Bluetooth device, the light flashes encoding Bluetooth address data; and
decoding the Bluetooth address data encoded in the light flashes.

7. The method of claim 6, wherein the light flashes comprise infrared light emitted by a light emitting diode.

8. The method of claim 1, wherein transferring by the intermediary device, the converted Bluetooth address data to reserved memory in the mobile communication device comprises:
transmitting the converted Bluetooth address data to the mobile communication device for storage in reserved memory.

9. The method of claim 1, further for pairing the Bluetooth device and the mobile communication device, the method further comprising:
retrieving the converted Bluetooth address data from the reserved memory in the mobile communication device; and
activating a pairing function in the mobile communication device to accomplish exchange of a link key and an encryption key between the Bluetooth device and the mobile communication device.

10. The method of claim 9, further comprising:
suppressing a discovery process;
installing the link key in the Bluetooth device;
installing the encryption key in the Bluetooth device;
installing the link key in the mobile communication device; and
installing the encryption key in the mobile communication device.

11. A method for preparing a mobile communication device for pairing with a Bluetooth device, the mobile communication device having a processor, the method comprising:
suppressing a discovery process;
providing Bluetooth address data to the mobile communication device through an intermediary input device operatively connected to the processor of the mobile communication device; and
transferring the Bluetooth address data to reserved memory of the mobile communication device to prepare the mobile communications device for pairing with a Bluetooth device.

12. The method of claim 11, wherein the input device is a bar code reader, and providing Bluetooth address data to the mobile communication device through an input device comprises:
reading, with a bar code reader, Bluetooth address data encoded in a bar code; and
decoding the Bluetooth address data encoded in the bar code.

13. The method of claim 11, wherein the input device comprises at least one selected from the group of a charged-coupled device camera and a charge modulation device camera for capturing a bar code image, and providing Bluetooth address data to the mobile communication device through an input device comprises:
capturing, with at least one selected from the group of a charged-coupled device camera and a charge modulation device camera, an image of Bluetooth address data encoded in a bar code;
deciphering the image to form Bluetooth address data encoded in a bar code; and
decoding the Bluetooth address data encoded in the bar code.

14. The method of claim 11, wherein the input device comprises a microphone, and providing Bluetooth address data to the mobile communication device through an input device comprises:
receiving with the microphone, dual tone multi-frequency tones in a predetermined format emitted by the Bluetooth device, the tones encoding Bluetooth address data; and
decoding the Bluetooth address data encoded in the dual tone multi-frequency tones.

15. The method of claim 11, wherein the input device comprises a light sensor, and providing Bluetooth address data to the mobile communication device through an input device comprises:
receiving with the light sensor, light flashes in a predetermined format emitted by the Bluetooth device, the light flashes encoding Bluetooth address data; and
decoding the Bluetooth address data encoded in the light flashes.

16. The method of claim 11, further for pairing the Bluetooth device and the mobile communication device, the method further comprising:
retrieving the converted Bluetooth address data from reserved memory of the mobile communication device; and
activating a pairing function in the mobile communication device to accomplish exchange of a link key and an encryption key between the Bluetooth device and the mobile communication device.

17. A system for injecting a Bluetooth address of a Bluetooth device into a mobile communication device, the system comprising:
a Bluetooth device;
an intermediary device;
a mobile communication device coupled to the Bluetooth device via the intermediary device;
a reception module for receiving by the intermediary device, Bluetooth address data associated with a Bluetooth device;
a conversion module for converting by the intermediary device the Bluetooth address data to a format suitable for storage in the mobile communication device, to form converted Bluetooth address data; and
a transfer module for transferring by the intermediary device, the converted Bluetooth address data to reserved memory in the mobile communication device.

18. The system of claim 17, wherein the intermediary device is remote to the mobile communication device.

19. The system of claim 17, wherein the intermediary device comprises a bar code reader, and the reception module is configured to read, with the bar code reader, Bluetooth address data encoded in a bar code format, and decode the Bluetooth address data encoded in the bar code format.

20. The system of claim 17, wherein the intermediary device comprises at least one selected from the group of a charge-coupled device camera and a charge modulation device camera, and the reception module is further configured to capture, with the selected at least one of the charge-coupled device camera and the charge modulation device camera, an image of Bluetooth address data encoded in a bar code, to decipher the image to form Bluetooth address data encoded in the bar code, and to decode the Bluetooth address data encoded in the bar code.

21. The system of claim 17, wherein the intermediary device comprises a microphone, and the reception module is further configured to receive with the microphone, dual tone multi-frequency tones in a predetermined format emitted by the Bluetooth device, the tones encoding Bluetooth address data, and decode the Bluetooth address data encoded in the dual tone multi-frequency tones.

22. An apparatus for injecting a Bluetooth address of a Bluetooth device into a mobile communication device, the apparatus comprising:
a processor module configured to control the operations of the apparatus;
a mobile communication device link module coupled to the processor, the mobile communication device link establishing a connection between the apparatus and the mobile communication device;
a wireless link module coupled to the processor module, the wireless link module establishing a connection between the apparatus and the Bluetooth device;
a reception module for receiving Bluetooth address data associated with a Bluetooth device via the wireless link;
a conversion module for converting the Bluetooth address data to a format suitable for storage in the mobile communication device, to form converted Bluetooth address data; and
a transfer module for transferring the converted Bluetooth address data to reserved memory in the mobile communication device via the mobile communication device link.

23. The apparatus of claim 22, wherein the mobile communication device is identified by an identification code, the apparatus further comprising:
a storage module for storing the Bluetooth address with the identification code of the mobile communication device.

24. The apparatus of claim 22 further comprising:
a discovery suppression module for suppressing the discovery process in finalizing a pairing process.

25. The apparatus of claim 22, wherein the wireless link is a Bluetooth link.

26. The apparatus of claim 22, wherein the conversion module is adapted to convert Bluetooth address data embedded in at least one selected from the group of an image of Bluetooth address data encoded in a bar code, a predetermined dual tone multi-frequency format, light flashes in a predetermined format emitted by the Bluetooth device, an RFID tag, to a format suitable for storage in the mobile communication device.
